(19) United States
(12) Patent Application Publication
(10) Pub. No.: US 2013/0302763 A1
(43) Pub. Date: Nov. 14, 2013

(54) INTERACTIVE SYSTEM AND METHOD OF MODIFYING USER INTERACTION THEREIN

(71) Applicants: Thomas Joseph Edwards, Gwynedd (GB); Thomas Martin Owen, Anglesey (GB)

(72) Inventors: Thomas Joseph Edwards, Gwynedd (GB); Thomas Martin Owen, Anglesey (GB)

(73) Assignee: SMALTI TECHNOLOGY LIMITED, Holywell (GB)

(21) Appl. No.: 13/885,373

(22) PCT Filed: Nov. 14, 2011
(86) PCT No.: PCT/GB2011/052219

§ 371 Date: Jul. 25, 2013

(30) Foreign Application Priority Data
Nov. 15, 2010 (GB) 1019285.4

(51) Int. Cl. G09B 5/02

(52) U.S. Cl. CPC G09B 5/02
USPC 434/159; 434/362

(57) ABSTRACT

Interactive blocks (12, 212) that present changeable individual characterizations (118) and sensory output based on meaningful assemblage of sensed individual characterizations from similar juxtaposed blocks (12, 212) are configured to record their interactions to produce an historic log or both successful interactions that yield a sensory output or failed interactions that produce no logical or meaningful sensory event. Uploading of the historical log (158) permits automated computational assessment of all interactions, with a centralized computing resource dynamically arranged to cause selective download of new content and/or new operating instructions to one or more of the interactive blocks (12, 212) based of identification of trends in the historical record. The new content and operating instructions modifies operation of cooperating blocks to produce different, processor controlled individual characterizations an/or sensory outputs that reinforce learning or identified mistakes arising from inappropriate manipulation of the interactive blocks. The interactive blocks (12, 212) can be realized as physical entities or otherwise in a virtual screen environment, with the sensory output being visual, audible and/or a haptic response.

### BACKGROUND TO THE INVENTION

This invention relates, in general, to an interactive system and method in which processor-controlled objects interact with each other to effect a user-perceptible change in an output state in one or more of the objects. More particularly, but not exclusively, the invention relates to manipulable physical blocks or tiles (or their virtual animated equivalent) that each or collectively generate a sensory output indicative of an instantaneous, but time-varying, value or characteristic attributed to the block or tile as further influenced by its locally sensed environment in which the block is relatively positioned. The present invention is especially relevant to educational devices in which user-interaction and manipulation of such interactive blocks reinforces learning processes through the generation of complementary sounds and/or visual output, or to systems in which the blocks, tiles or their virtual equivalent act as a control interface.

Aspects of the invention also relate to the establishment of a secure social network that makes use of position-aware interactive block technology to firm micro-networks, which interactive block technology is sometimes referred to herein by its UK-registered trade name iTiles® (in the single or plural).

### SUMMARY OF THE PRIOR ART

In EP 1899939, the underlying configuration and functional operation of manually manipulable interactive devices is described. Particularly, a processor-controlled block or tile has the ability to communicate “characterization” information to similar devices that are detected and assessed to be positioned within a meaningful range. Based on the instantaneous characterization, a sensory response (typically in the form of sound or visual output) is generated by one or more of the blocks either in unison or in sequence, with the sensory response generally dependent upon realization of a meaningful interaction between currently presented characterizations on each of the interacting blocks or tiles. Moreover, based on relative positions between the blocks or tiles and a determination that a meaningful combination of characterizations has occurred, one or more of the blocks may dynamically and automatically take on a new characterization, expression or appearance and thus present a new sensory output. The blocks are therefore arranged to communicate data to each other, e.g. over a low power wireless link.

In EP 1899939 each changeable individual characterization may comprise visual display material (such as a static or animated image) or audio output material or both, which individual characterization will vary depending on the particular application or purpose of the device or devices. For example, visual display material may comprise a letter or group of letters (e.g. phoneme) or word or words, and the sensory response may comprise speech corresponding to a word or phrase or sentence spelt out by the letters or words. In another application, visual display material may comprise a number or mathematical symbol, and the sensory response may comprise speech relating to mathematical properties of the numbers on the devices. In yet another application, visual display material may comprise a musical symbol and the sensory response may be an audio musical response. In an example in which the characterization comprises audio output material, this may comprise the audio equivalent of any of the examples of visual display material given above. Each device therefore includes at least a visual display device for presenting the current individual characterization of the block as a sensory output, with each device typically also including an audio generator.

The system in EP 1899939 is therefore particularly effective as a learning tool, since a user is able to manipulate the blocks in the context of game play to produce a meaningful logical or artistic outcome that is itself reinforced by sound and/or images.

Several years after the publication of EP 1899939, the significance of dynamically changeable interactive devices as learning tools and interfaces was demonstrated by Sifteo, Inc., in a TED concept presentation of the “Siftables” table-top gaming platform. Indeed, the functionality provided by the Siftables platform mirrors the disclosure in EP 1899939, as reflected by the video at http://www.foundrygroup.com/wp/2010/05/foundry-group-invest-in-sifteo/ and the corresponding disclosure in US patent application 2009/0273560.

Data-sharing technologies do exist in the general computing field, although these are generally interfaced specific and provide no interactive educational experience.

For example, in the article “iClouds: Peer-to-peer Information Sharing in Mobile Environments” by Andreas Heinemann et al, a ubiquitous computer system is proposed in which information is made available to an entire group of people and in which the distributed information is based on individual user contributions through peer-to-peer communications and data exchange. In short, iClouds provides a selective file sharing environment between affiliated groups of users each having a personal PDA. Each iCloud-enabled PDA periodically scans the local vicinity to identify affiliated devices (or nodes), and each device provides an indication of its data needs (or “iWish”) and its available data contribution (or “iHave”). The definition of the PDA's data needs permits the PDA to control access by essentially firewalling unsolicited data downloads from a third party device, while the iHave list allows selected data to be selectively pushed or provided to another interested iCloud-enabled PDA having a matching iWish data requirement.

In Proem “A Peer-to-Peer Computing Platform for Mobile Ad Hoc Networks” by Korteum (related to the iClouds Project and detailed at URL:http://web.archive.org/web/20050306065830/http://iclouds.tk,informatik.tu-darmstadt.de/iClouds/Publications.html) it is explained that PDAs and other cellular devices may use a variety of technologies, including Bluetooth, to establish a network connectivity of devices to share (through transmission) information. Such devices merely replicate data or allow a user of the device to modify the data based on considered action of the user. The PDAs described by Korteum are not sufficiently intelligent to assess the surrounding network of devices and assimilate information to produce an entirely new result that is displayed on the device, but merely allow data sharing.

EP-A-1486237 relates to the use of two, correctly orientated and juxtaposed polyhedral objects that interact to provide stimulus that rewards the correct juxtaposition of particular polyhedral objects. Particularly, when a picture of one cube is placed adjacent the same picture on the other cube, with both pictures the right way up, this is detected and the associated sound is emitted. The pictures on each picture-bearing face is permanently fixed and does not change based on any surrounding block. Indeed, the sound-emitting systems are arranged to emit a secondary sound only upon detecting that the first and second polyhedral object have been juxtaposed with a further face of the first polyhedral object facing a further face of the second polyhedral object and with the picture on the first picture-bearing face of the first polyhedral object at its intended angle being observable adjacent to a picture on a second picture-bearing face of the second polyhedral object when looked at in a direction substantially parallel to the further facing faces. EP-A-1486237 therefore permits the building of an interactive storyboard that reinforces learning by providing a story that unfolds, with each picture on a picture-bearing face forming a frame in a sequence depicting the story. The images of the polyhedral objects relate to the story to be told and are thus permanently fixed.

U.S. Pat. No. 4,936,780 to Cogliano merely describes a block with indicia applied to only one surface and a sensor that triggers sound through a speaker when the sensor is triggered. Again, like EP-A-1486237, there is a permanent relationship between the applied image and their respective surfaces. No change in the output results from the detection of any neighbouring block(s).

U.S. Pat. No. 5,823,782 describes a “working platform” or reading table that uniquely identifies the representation of the character on each block and also the positioning of the block relative to other blocks. However, there is a permanently fixed relationship between the characters on each assigned face of each block, i.e. the blocks may include between one and six characters on its respective surfaces the block will include six different transmission systems, with each character/transmission system pair provided proximate to opposed surfaces from each other. Indeed, the working platform identifies not only the character information but also the location of a block relative to other blocks so as to allow identification of whole words, phrases and/or mathematical results. Therefore, the working platform includes a grid of readers.

U.S. Pat. No. 5,320,358 describes the use of different forms of sensor trigger, while U.S. Pat. No. 6,149,490 to Hampton provides background to the automated control of the motors (through a compact and highly controllable form of drive system) based on limited communication between toys, especially mannequins. Particularly, in U.S. Pat. No. 6,149,490, the toy includes sensors, e.g. IR transmitters and receivers, for allowing communication between the toys. For instance, if several of the toys are placed in close proximity, and one detects a sensory input that the controller interprets as instructions to make the toy dance, e.g. four loud, sharp sounds in succession, the motor of the toy will be activated so that cam of the foot portion will be rotated by the control shaft to cause repetitive pivoting of the foot portion, i.e. dancing of the toy. This toy will then signal the other proximate toys via the IR link to begin to dance.

In the article “Tangible Interfaces for Manipulation and Exploration of Digital Information Topography” by Gorbet et al, published in the Proceedings of the CHI '98, Apr. 18-23, 1998, ACM, Los Angeles, Calif., USA (hereinafter “Gorbet”), the author describes a system in which permanent images are presented on each so-called “Triangle” (or “Tiles”) for an entire application. Indeed, the images are always story specific or application specific. Furthermore, in Gorbet, output from its “Triangles” is not through the Triangle itself, but rather via a connected computer that interprets the associations formed between connected Triangles, i.e. through the “mother triangle”. Specifically, these mother triangles differ from others Triangles in that the mother Triangle has a cable that provides power to itself and to other triangles, as well as a serial communication to a host computer. The output in Gorbet is therefore not achieved in the device nor is it achieved in the response generator of a similar manipulable device, but rather the output of Gorbet entirely emanates from a connected PC.

The article by Laerhoven et al, namely “Using an Autonomous Cube for Basic Navigation Input” (Proceedings of the 5^{th} International Conference on Multimodal Interfaces, ICMI '03, 5-7 Nov. 2003) relates to a system that permits the identification of the orientation of a cube by using a combination of dual-axis accelerometers and a capacitive sensor (for proximity measurement). The cube is arranged to “output information about itself to its environment when its state has changed or when a certain gesture is performed”. In a similar way to a conventional die, the faces of the tube are permanently labeled. In operation, the cube's relative orientation is broadcast when the cube senses that it is being manipulated, while the final orientation of the cube defines a function that is performed at a remote device, such as an audio system.

Finally, in relation to computer interfaces, the articles “The Soul of ActiveCube—Implementing a Flexible, Multimodal, Three-Dimensional Spatial Tangible Interface” by Watanabe et al [ACM Computers in Entertainment, Vol. 2, No. 4, October 2004, Article 6b] describes a 3D-modelling system. According to this article “ActiveCube allows users to construct and interact with three-dimensional (3D) environments using physical cubes equipped with input/output devices. Spatial, temporal and functional consistency is always maintained between the physical object and its corresponding representation in the computer” (see page 1, first paragraph). The premise behind Watanabe is that “it would be easier to understand what happens in the virtual environment because the constructed object would act as a physical replica of the virtue structure” (see page 2, second paragraph, final sentence). Watanabe provides a solution by having “the computer recognize the 3D structure of these connected cubes in real time, so consistency is always maintained between the physical object and its corresponding representation in the computer” (see page 2, third paragraph). To establish some sense of orientation, Watanabe describes the necessity for communication between the cubes and a remote host PC, with the host PC operating to update a connection-status tree (CS-tree) to manages the connection status information in the tree structure.

In summary, according to Watanabe (in paragraph 13), the remote computer determines the orientation of the cubes and what this represents, e.g. a configuration of a virtual plane of a remote display. The remote computer also determines the corresponding overall state of that virtual plane of the computer's display given detected movement of the real cube(s). The generation of an alert on a block (under the control of a remote computer responsible for the virtual representation) does not however change the individual characterization, i.e. the assigned meaning of an ActiveCube, to something entirely different (such as a changeable individual characterization represented by display of visual display material taking the form of a letter, a group of letters, a word, words, a number, a mathematical symbol, or a musical symbol) as otherwise occurs in EP 1899939. Rather, each cube in Watanabe has a uniquely assigned function that never changes between the context of each physical cubes and its corresponding virtual representation.

Advanced learning systems are therefore desirable and find wide applications both in school and home environments. Advanced learning systems are especially useful when they engage with the user in an intuitive fashion and where such systems can be focused to support development of areas of potential intellectual weakness.

### SUMMARY OF THE INVENTION

According to a first aspect of the invention there is provided a manually manipulable device comprising: a processor arranged to control operation of the device; a power source providing power to the device; a visual display unit arranged to display visual display material; a response generator for generating a sensory response; a communications unit configured, in use, to effect communication with a similar manually manipulable device; and wherein the device is configured to present a changeable individual characterization represented by display of visual display material and wherein the processor generates a sensory response in its response generator or a sensory response in a response generator of a similar device, the generated sensory response dependent upon at least one of the individual characterization presented by the device itself and an individual characterization presented by the similar device, the sensory response output by the response generator follows manual manipulation of the device and interaction between changeable individual characterizations, the interaction dependent upon relative position between the device and at least an adjacently located interacting device; the manually manipulable device further includes a position and positioning and proximity device configured to sense and determine the relative position; and wherein: the changeable individual characterization of the manually manipulable device represented by display of visual display material takes the form of at least one of: a letter; a group of letters; a word; words; a number; a mathematical symbol; or a musical symbol; the individual characterization on the similar device represented visually as: a letter; a group of letters; a word; words; a number; a mathematical symbol; or a musical symbol, and the individual characterization of the manually manipulable device is controlled by the processor and selectively changeable over time based upon: i) the nearby detection of the similar device; and ii) the individual characterization presented on that similar device at the time of its detection; the processor configured or arranged to effect at least one function selected from the group consisting of: a) dynamically altering content representing changeable individual characterizations, the content varied in response to historically accumulated manipulation data relating to interactions experienced by the device over a selected period of time; b) determining available interactions with adjacent blocks and generating a sensory-perceivable prompt to indicate at least one possible interaction that would result in a meaningful arrangement of individual characterizations presented by similar blocks; and c) providing interaction data arising from manipulation and interaction between blocks; and d) providing reports or scoring of manipulations and interactions between blocks.

In a preferred embodiment, the processor is further configured or arranged to: record and store successful interactions that combine to generate a sensory output; record and store failed interactions that produce no logical or meaningful sensory event from a relative positions arising between proximately located devices; wherein the records are, upon request, uploadable.

The processor may be further configured or arranged to permit selective modification in the responsiveness of the sensory output to relative position data.

Another aspect of the invention provides a manually manipulable device having: a processor; a display supporting presentation of a first individual characterization having a first property, the first individual characterization changeable over time by processor control; a communication unit allowing data to be received and transmitted to said manually manipulable device; and a sensor to sense proximity and relative position of a second similar device movable independently of said first manually manipulable device, the second similar device brought, in use, into data communicating proximity with said manually manipulable device through manipulation of one of said manually manipulable device and the second similar device, the second similar device further presenting a second changeable individual characterization independent of the first individual characterization, the second changeable individual characterization having a second property different to the first property and wherein communication of data provides a context about meaningful interaction between said manually manipulable device and at least the second similar device; wherein the said manually manipulable device is arranged or configured: during interaction between the first individual characterization and at least the second individual characterization, to inherit a new property and to change the first individual characterization to a third individual characterization, wherein the new property and the third individual characterization of said manually manipulable device are dependent on one of: (i) the second individual characterization on the second similar device; and (ii) an interacting combination of the first and second properties and the first and second characterizations; and to effect at least one function selected from the group consisting of: a) dynamically altering content representing changeable individual characterizations, the content varied in response to historically accumulated manipulation data relating to interactions experienced by the device over a selected period of time; b) determining available interactions with adjacent similar devices and to generate a sensory-perceivable prompt to indicate at least one possible interaction that would result in a meaningful arrangement of individual characterizations presented by similar devices; and c) providing interaction data arising from manipulation and interaction between devices; and d) providing reports or scoring of manipulations and interactions between devices.

In another aspect of the invention there is provided a learning system comprising a multiplicity of interacting blocks according to any preceding claim, the system further including: a computing system having a database of content, the computing system responsive to historically accumulated interaction data uploaded, in use, from one or more of said interacting blocks, wherein the computing system is configured to arranged to: analyze historically accumulated interaction data; and identify trends in the historically accumulated interaction data; and in response to identification of any trend, to retrieve content from the database and download the content to at least one the multiplicity of interacting blocks, the content changing at least one of: the changeable individual characterizations; a nature of interactions between individual characterizations; and sensory outputs arising from interactions between individual characterizations presented on different ones of the multiplicity of interacting blocks.

At least one of access to the computing system and access to the content in the database is subject to an on-line log-in process and payment of a fee.

In a particular embodiment, the computing is automatically arranged to cause selective download of new content, new operating instructions and new content and operating instructions to one or more of the interactive blocks based on either at least one of: identified trends in the historically accumulated interaction data; and educational scores reflecting success or failure rates in recorded interactions between interacting blocks.

In a third aspect of the invention there is provided a computer program product that, when run on a computer, includes code that is arranged to: generate a visual display containing a plurality of user-positionable objects that each present a changeable individual characterizations, the changeable individual characterizations represented by display of visual display material cause generation of a sensory response associated with at least one interacting block, the generated sensory response dependent upon at least one of the individual characterization presented by a first user-positionable object and an individual characterization presented by a second user-positionable object, the sensory response output following manipulation of at least one of the first and second objects and interaction between changeable individual characterizations presented thereon, the interaction dependent upon relative position between the first object and at least the second object adjacently located and interacting therewith; determining a relative position and proximity between user-positionable objects; selectively change over time the individual characterizations based upon: i) the determined position of similar objects; and ii) the individual characterization presented on those similar objects at the time of their detection; and at least one of: a) dynamical alteration of content representing changeable individual characterizations, the content varied in response to historically accumulated manipulation data relating to interactions experienced between user-positionable objects over a selected period of time; b) determine available interactions between adjacent objects and cause generation of a sensory-perceivable prompt to indicate at least one possible interaction that would result in a meaningful arrangement of individual characterizations presented by the objects; and c) accumulate and provide reports derived from manipulation and interaction between objects; and d) accumulate and score manipulations and interactions between objects, wherein the changeable individual characterizations of the objects are represented by display of visual display material taking the form of at least one of: a letter; a group of letters; a word; words; a number; a mathematical symbol; an image; or a musical symbol.

In yet another aspect of the invention there is provided a method of altering sensory responses in an education device or toy having a display with a changeable individual characterization represented visually as: a letter; a group of letters; a word; words; a number; a mathematical symbol; an image; or a musical symbol, the individual characterization changeable with time based upon i) the nearby detection of the similar device; ii) the individual characterization presented on that similar device at the time of its detection; and iii) the relative position between interacting devices, and wherein the sensory response is dependent upon at least one of the individual characterization presented by the device itself and an individual characterization presented by the similar device, the sensory response output following: manual manipulation of the device; interaction between changeable individual characterizations; and relative position between the device and at least an adjacently located interacting device; the method comprising: a) dynamically altering content representing changeable individual characterizations presentable by the educational device, the content varied in response to historically accumulated manipulation data relating to interactions experienced by the device over a selected period of time; b) determining available interactions with adjacent devices and generating a sensory-perceivable prompt to indicate at least one possible interaction that would result in a meaningful arrangement of individual characterizations presented by similar devices; c) providing interaction data arising from manipulation and interaction between devices; and d) providing reports or scoring of manipulations and interactions between devices.

The present invention therefore advantageously augments the functionality in EP 1899939 by allowing the interactive arrangement to target and dynamically manage content provided on or by each individual physical or virtual block, tile or object. By modifying operation of the blocks based on historically acquired data pertaining (for example) to block interactions and block positioning by the user, the intelligence in the system operates (both initially and over time) to reinforce aspects of learning that the user finds troublesome or easy. Consequently, the blocks, tiles or processor-controlled tablet (in a 2-D virtual software realization) can independently provide user-prompts and assistance to encourage the user to make an appropriate and meaningful selection, position and/or orientation of blocks and to reward the selection through an appropriate sensory output or stimulus. In this way, the effectiveness of the system is increased because the level of enjoyment is enhanced and the system tailored to a user's own unique level of aptitude/attainment.

Therefore, a device according to the invention is preferably a fully programmable, multifunctional device which can be adapted for use as a learning aid in relation to language, mathematics or music or other subjects. Such a device can be readily adapted to be used in the manner of known multi-component, educational apparatus such as Cuisinaire rods (used to teach arithmetic), dominoes and jigsaws, each component (rod, domino or jigsaw piece) being embodied in the form of a device or a virtual object in an electronic touch-screen environment, which processor-controlled device or screen is then able to respond visually and/or audibly to enhance the experience of the user of the apparatus.

The invention is applicable to diverse areas which include, but are not limited to, play, entertainment, adornment and decoration, environment, industry and learning of for example, languages, mathematics and musical skills/knowledge.

Play applications may include a variety of playful games using the blocks and, optionally, a tray of blocks. These include new games as well as enhancements of typical existing board and card games with additional features (by virtue of the fact the pieces (blocks) can change their image and emit sounds) and the board (interactive base) can also change its image. Further, new forms of toys, such as farmyards and zoos, can be created and become elements of animated stories through presentation of story-telling, interactive content.

In relation to adornment and decoration, in the educational context, interactive blocks of the various embodiments of the invention can be worn as badges, thereby enabling students to role play their various functions (letters, sounds, numbers) and interact with other badge-wearing children to form words, tunes and equations. Beyond this, such interactive blocks have implicit emotive, aesthetic, interactive and descriptive capabilities. Blocks in combination can be used to trigger social and artistic interactions between people or create more complex installations, including external control of physical equipment.

In environment and industrial settings variations of the devices can enable audio and visual data/systems alone or in combination (e.g. for health and safety measurement and control).

### SUMMARY OF THE INVENTION

Exemplary embodiments of the present invention will now be described with reference to the accompanying drawings in which:

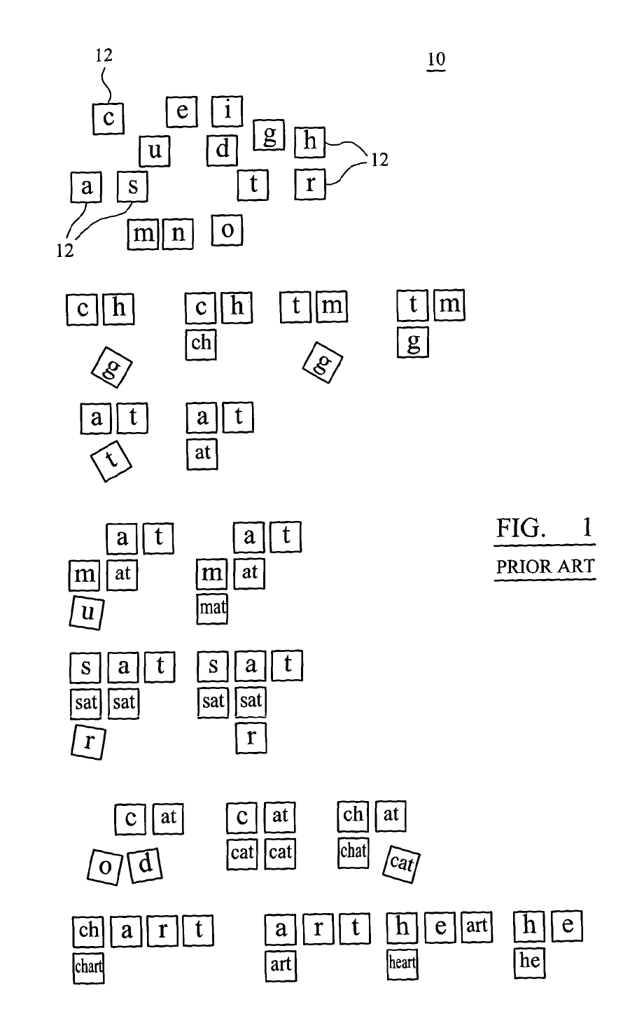

FIG. 1 illustrates how processor-controlled interactive blocks of the prior art interact with one another in the course of their manipulation;

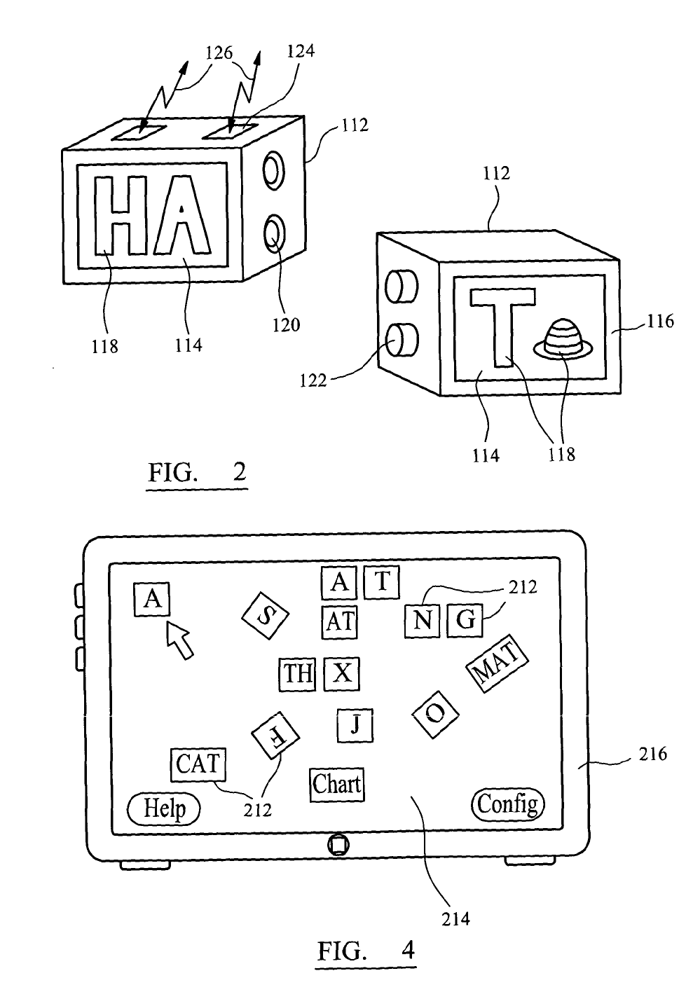

FIG. 2 is a representation of exemplary configurations for an interactive block shown from left and right perspectives;

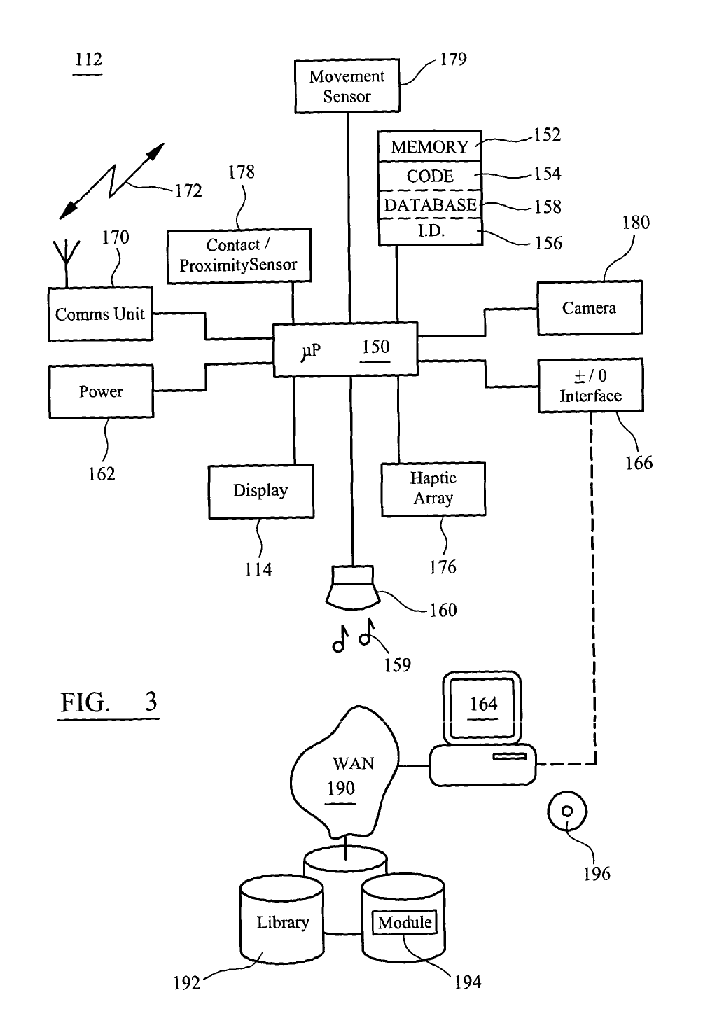

FIG. 3 is a block diagram schematically illustrating preferred functional components of the interactive block of FIG. 2;

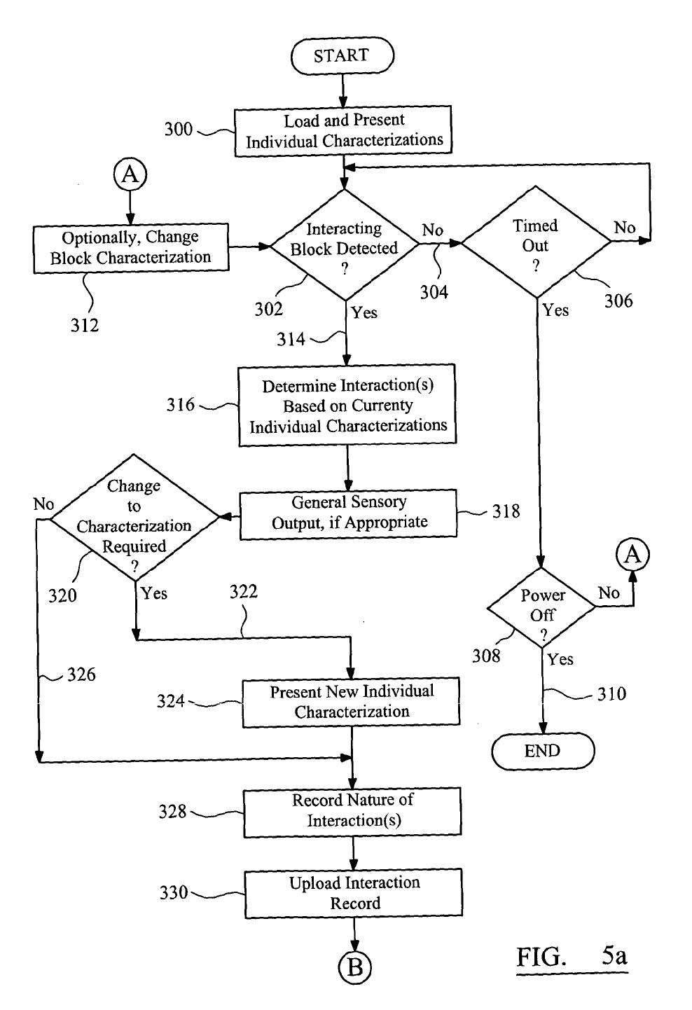

FIG. 4 shows a software-based implementation of interactive objects in the context of a processor-controlled touch screen;

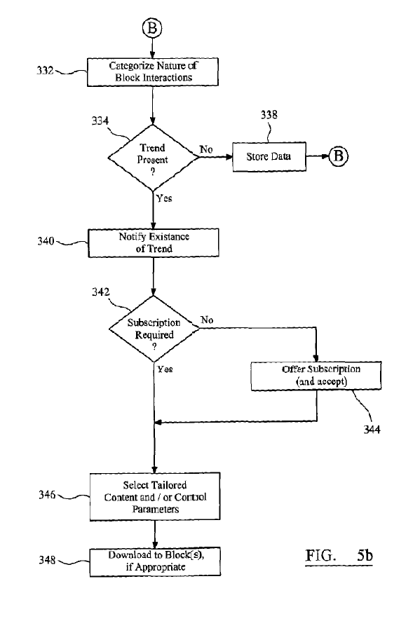

FIG. 5 (composed from FIGS. 5a and 5b) is an exemplary flow diagram illustrating mechanisms of assessing and supplying varying content, especially with respect to the blocks of FIGS. 2 and 3; and

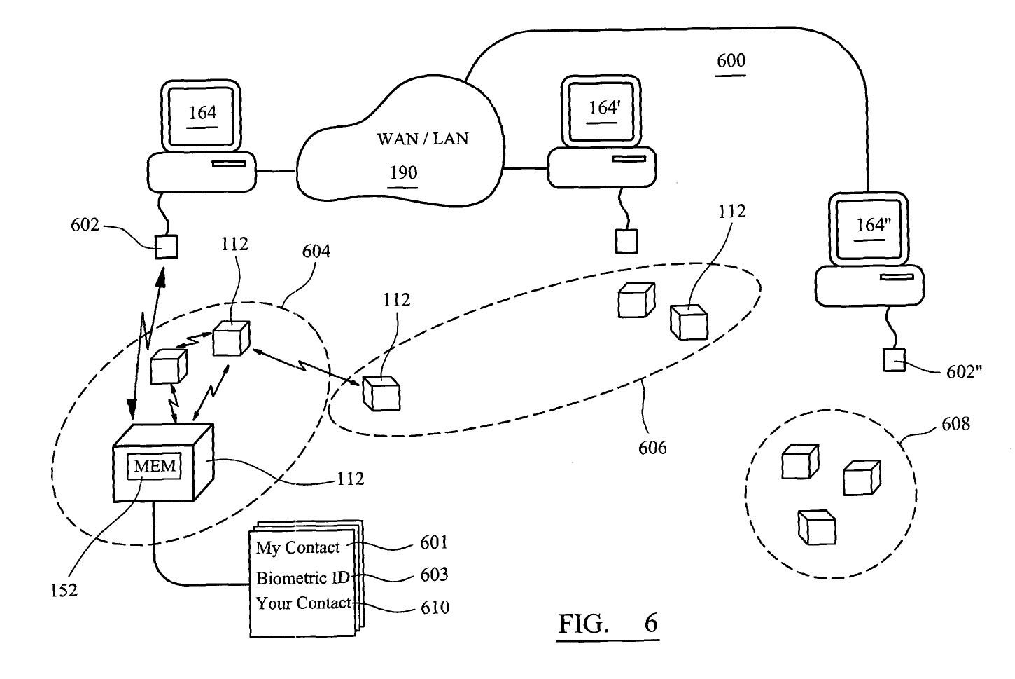

FIG. 6 shows a preferred social network that makes use of interactive tiles to establish connectivity.

### DETAILED DESCRIPTION OF A PREFERRED EMBODIMENT

To provide an operational context for the present invention, reference is made to FIG. 1 and the processes by which individual characterizations for specific manipulable blocks (and associated sensory responses) are presented and used by an individual (nominally named “Sam”). More specifically, FIG. 1 provides an exemplary context in which blocks displaying letters, groups of letters and words interact, with this originally described in EP 1899939.

Sam is four-and-a-half years old. She's just started in her reception year at school where she's learning to read and write. Her parents are keen to help her learn at home and buy her a set 10 of processor-controlled blocks contained some pre-loaded, age-appropriate reading and control software.

Sam opens the box and randomly distributes the blocks 12. Each block 12 is preferably displaying a different lower case letter (i.e. a different individual characterization), although this may not always be the initial default setting.

Sam goes to pick one up and the unit sounds the letter it is displaying, e.g. Ye. Moving each of the blocks she realizes they all do the same. Alternatively, once activated, if there's say fifteen seconds of inactivity, i.e. non-manipulation within the set, one block may be configured to generate an audio prompt such as “Try spelling a word, how about cat”. Pressing on or moving a block causes that block to generate an audio response representative of its individual characterization, e.g. “c sounds like /c/. /c/ is for cat. Move the blocks together to spell cat”. Rather than an audio output, the block may display an image of a cat, the image being either a picture or an animation.

Sam puts two of the blocks next to each other. The two blocks 12 detect each others proximity and (if appropriate) orientation and/or order. If the processors assess the relative proximity to be sufficiently close to effect a deliberate relation, they communicate their current individual characterizations. For example, a sensed touching arrangement between contacts on adjacent blocks would indicate a necessity to communicate individual characterizations and to assess any meaningful interaction therebetween.

Starting with the block on the left, the blocks read in turn the letters they are displaying. For example, ‘/d/, /o/’. They then read the combined sound. For this example the blocks (either individually or in concert) say, i.e. annunciate, the word/sound “do”.

When Sam puts three random letters together (e.g. ‘/c/, /f/, /g/’), they make no sound since no meaningful interaction can be acquired by the block's processors from the combination arising from their respect relative positions, combined interactions and current individual characterizations.

Sam then plays around with some different combinations until a word is spelt. For example, the /c/, /a/ and /t/ blocks are arranged juxtaposed. The meaningful detected interaction causes at least one of the blocks to announce “You've spelt cat. Well done!”. At this point, the control processor refers to a stored software library and generate the image of a cat for display. The image of the cat may, for example, be arranged to leap and run around (between screens on different blocks), with any audio generator producing the sound of a miaow. After a short time, the blocks 12 typically then resume display of their individual characterizations, namely /c/, /a/ and /t/.

The controlling processor(s) may also operate to prompt the child's next action. For example, the audio generator may output the suggestion: “‘Now you can copy the word you've made onto its own block, by placing a new block below the others. Or you can try and spell another word”.

When Sam puts another block relatively closely below the word “cat” that she's previously spelt out, the word is caused to jump down onto that single block. The characterization on the new block now says “cat” when it is pressed or when it otherwise subsequently interacts. The three original blocks each containing one of the letters /c/, /a/ and /t/ may retain that own individual characterizations, or they may alternatively scramble to produce new individual characterizations. Scrambling may be prompted, for example, by shaking each block or by pressing the block for an extended period.

Therefore, the three blocks that originally spelt the word are now free to be used for another word, such as through re-arrangement into another combination, e.g. /a/ and /t/. with /c/ block discarded by being moved out of interacting range.

As described above, each block is individually responsive to touch or movement and reacts audibly and visually depending upon what it displays.

If each block is responsive to both truck and movement separately, then each can have a secondary response, such as giving an example of use.

If a letter is displayed, e.g. “c”, the block sounds the letter as in it is said in the alphabet and phonetically. For example, “C. C sounds like /c/ for cat”. An animation may play on the screen relating to the letter and the example given. A secondary response might suggest what the user can do next? For example, “Can you spell Cat?”.

If a word is displayed e.g. “cat”, the block sounds the phonetic letters for the word. For example, ‘/c/, /a/, /t/ spells cat’. An animation relating to the word plays on the screen. A secondary response might suggest the spelling of another word from the available letters if this is possible.

If a phonetic sound is displayed e.g. “ch”, the block sounds the combined phonetic sound “/ch/ as in lunch”. The screen displays an animation of some food being eaten.

When blocks are placed next to each other they react depending what is on each; this requires communication of block identities or current individual characterizations. Meaningful interaction could result in the generation of a phonetic sound e.g. ‘/ch/’, a word, e.g. ‘cat’, a change in image (e.g. a colour or texture change resulting from two adjacent blocks having different colours or different granularities) or the annunciation of random letters, e.g. ‘/k/, /r/, /f/’, subject to there being a programmed desire to cause limited annunciation of effectively a random and meaningless combination of relatively closely positioned blocks or objects.

If the user places individual blocks alongside each other then they respond according to the combination of letters they display.

If a phonetic sound is created “ch”, the blocks (either in unison or in succession, depending upon programming) sound the combined sound, ‘/ch/’. They could also generate a short sensory response as an example of its use, e.g. a audible statement such as “/ch/ as in lunch, yum, yum, yum”.

If a word is created such as “cat”, the blocks sound the individual letters followed by the word itself. For example, “/c/, /a/, /t/, spells cat. Well done, you've spelt cat”. It is preferred that each block announces its respective individual characterization since such a audible sensory response consolidates the visually displayed material, i.e. the individual characterization, on each respective block. The visual display(s) on the block may play a short animation, such as an animated picture of a cat running between the two blocks. In a preferred embodiment, the animation may be repeated in the event that the relevant blocks are joined (but at least sufficiently proximate to each other as determined by an integrated proximity sensor) and, preferably, when one of said interacting blocks is pressed.

If a new word is created (such as a plural or a completely new word) through the addition of a letter or letters to a current word of phonetic sound, the response might be, for example, “/c/, /a/, /r/, /t/, spells cart. Are you coming for a ride?”’ or “/c/, /a/, /t/, /s/I spells cats. Here they come!”. One or more of the displays associated with each block then produces an appropriate animation (under control of the block processor(s)) according to the word that has been spelt, subject to the word having an associated animation in database accessible to the block(s). In the above examples, a horse and cart could be generated and be seen to drive on and off the screens, or several cats could start playing around.

If a random set of letters are placed next to each other, the sensory response may be muted or otherwise an error tone or error message generated. For example /d/, /f/, /x/, /g/’ might cause no sound to be generated and no animation is displayed.

Animation and sound will only be available for some of the words that can be created using the blocks, as stated in a related response database held in one or each block or a central control unit. Clearly, however, the size of the database is dependent upon assigned memory capacity and programming of responses. For younger children, an extensive database is less important since the words and structures likely to be produced are generally more rudimentary since they represent the building blocks of vocabulary and understanding.

In a preferred embodiment, if a user places one block adjacent the top of another block, the lower block inherits the property of the upper block. Of course, the triggering edge could be any edge or may follow from some other form of block manipulation, such as a double depression of a block brought into close proximity to the existing array or meaningful combination

Placing multiple blocks above or below will also cause a reaction between the blocks. For example, if the user places one block above another, and the top block shows ‘/b/’ and the lower block shows something else, the lower block will also become a ‘/b/’.

A user can place a word spelt out over several blocks onto one block by strategically placing a block below the meaningful array of blocks. This function can also be used to join a ‘c// and an ‘/h/’ to produce a ‘/ch/’ block.

If a user has spelt a word or phonetic sound using three individual blocks, for example, ‘/c/’, ‘/a/’ and ‘/t/’ spelling “cat”, the user can then place a fourth block under the three letter blocks and the word “cat” moves onto a single block, provided that the fourth block is detected to have been brought into an interacting position. However, if a user tries to copy two random letters onto a single block, the control program (executed by the processors) operates to prevent this because such a combination has no meaningful and logical use. For example ‘/z/’ and ‘/f/’ cannot be joined to produce a single ‘/zf/’ block or a single ‘/fz/’ block.

Likewise if the user has two word blocks that don't make a third word, they cannot be copied onto a single block. For example “cat” and “sat” cannot be joined to make a “catsat” block, since the programming and database recognize that such a combination is logically meaningless.

If a user has the word “cat” on a single block and wants to split it into three separate letters, the processors operate to support this splitting function. For example, a reverse manipulation performed by the user see three blocks placed below the word block. The three letters each split into their own assigned block in right to left order below, thereby changing the individual characterizations of each of the three blocks to ‘/c/’, ‘/a/’ and ‘/t/’.

FIG. 1 therefore illustrates the programmed operation of a set of blocks in which each physical block typically comprises a processor arranged to control operation of the device. Preferably, an internally-located power source provides power to the device. A visual display unit is arranged to display visual display material, while a response generator permits selective audio output. A communications unit is configured, in use, to effect communication with similar manually manipulable devices, such as through a wired or wireless connection. And a proximity sensor is configured to sense the close proximity of a similar device and, in fact, the relative position between devices. The term “proximity sensor” should therefore be construed broadly to reflect the overall functionality required to determine a deliberate and meaningful interaction and to cause an appropriate change in the sensory output generated by one or more interacting blocks.

In terms of functionality, the device is configured to present a changeable individual characterization represented by display of visual display material taking the form of at least one of: a letter; a group of letters; a word; words; a number; a mathematical symbol; or a musical symbol. The individual characterization may, in certain embodiments, take the form of an image, including that of a colour or texture. Each manually manipulable device is further configured such that manipulation thereof causes the processor to generate a sensory response in its response generator or a sensory response in a response generator of a similar device, wherein the generated sensory response is dependent upon at least one of the individual characterization presented by the device itself and an individual characterization presented by the similar device, the individual characterization on the similar device represented visually as: a letter; a group of letters; a word; words; a number; a mathematical symbol; or a musical symbol. The individual characterization may, in certain embodiments, take the form of an image, including that of a colour or texture. Indeed, the sensory response output by the response generator follows manual manipulation of the device and a first interaction between changeable individual characterizations, the first interaction dependent upon relative position between the device and at least an adjacently located interacting device and wherein a change in the relative position between interacting devices can produce a different sensory response arising from a second but different interaction between those individual characterizations presented by the respective interacting devices both before and after the relative change in position. Further, the individual characterization of the manually manipulable device is controlled by its processor (although remote control is also possible) and selectively changeable over time based upon: i) the nearby detection of the similar device; ii) the individual characterization presented on that similar device at the time of its detection; and iii) the relative position between interacting devices. Of course, in any 2D virtual representation of blocks or tiles on a touchscreen graphics tablet (or the like), the proximity sensing between deemed interacting blocks is controlled by a central processor of the graphics tablet, communications between 2D objects is virtual in that the central processor is programmed to be inherently aware of the presented content associated with each object and the visual display is effected by having a fixed shape, but movable array of pixels that are assigned to produce. Also, with a 2D realization, sensory audible output is centrally controlled from each graphics tablet, although multiple speakers (such as, without limitation, stereo, quad or Dolby® 5.1, etc.) are preferably individually controlled (in terms of balance/output power) to provide a perceivable point of sound emanation related to the location of the associated 2D object on the screen. A virtual 2D implementation therefore has replicated functionality, albeit that all the blocks are carried within the 2D display and interacting 2D objects can have their numbers selectively increased or decreased by a user.

In overview of the underlying process of FIG. 1, the system operates (in the exemplary case of alphabetical blocks or tiles) in the following manner:
1. Blocks are taken out of the box and scattered or arranged on the floor (or touchscreen).
2. The user puts ‘/c/’ and ‘/h/’ together and the blocks sound ‘/ch/’. They strategically position another block (currently presenting a ‘/g/’ as its individual characterization) underneath the ‘/c/’ and ‘/h/’ blocks to allow production of a new individual characterization ‘/ch/’ onto the former ‘/g/’ block. However, trying to copy ‘/t/’, ‘/m/’ onto another ‘/g/’ block doesn't work because there is no corresponding logical/meaningful phonetic result stored in the reference database.
3. The user joins ‘/a/’ and ‘/t/’ to make ‘at’, with this copied onto a single block.
4. The user ‘/m/’ is put in front of the “at” block to make a two-block combination reciting “mat”. The individual ‘/a/’ and ‘/t/’ blocks are still joined to the top of “at” block, but the individual letters have no direct effect to the ‘/m/’ block as they are not directly above, nor are they aligned but rather are to one side. By placing the ‘/u/’ block beneath the two block combination that produces the word “mat”, “mat” is copied onto the single block to change its characterization. The solitary “mat” block is then removed (not illustrated).
5. An ‘/s/’ block is now positioned in front of the ‘/a/’ and ‘/t/’ blocks to spell ‘sat’. As the ‘/m/’ of the two-block “mat” is now below the ‘/s/” block, the word “sat” is copied onto it. The word “sat” is also copied onto the “at” block, thereby changing its characterization and sensory output. The two adjacent “sat” blocks don't interact with each other as a new word or sound hasn't been created, especially since the combination “sat”, “sat” has no logical meaning Likewise when an “r” block is placed below either of the “sat” blocks nothing is copied down.
6. By using the blocks a chain of various words can be created.
7. New characterizations to a block may be periodically introduced by the user (or automatically after a predetermined time). For example, shaking of a block may cause the processor to change the presented individual characterization, with this avoiding a stalemate situation. Shaking of the block may be determined by processor-based monitoring, for example, of accelerometers within the block or tile. In a display-based implementation, a reset may be actuated by tapping an object on the touchscreen or, in the context of FIG. 4, by selecting the 2D object and oscillating its position through a hand movement. Alternatively, an upper or lower edge of the block may be touched to cause the natural/logical progression through characterizations presented on the display. For example, successive single tapping on the upper edge may cause the displayed characterization to change from a to b to c to d, whereas a tap on the lower edge would cause the sequence to be reversed from the currently displayed characterization, e.g. 100 to 99 to 98 to 97 and so on. By way of another example, colour changes may be based on a preset sequence corresponding to the natural light spectrum, e.g. red to orange to yellow to green and so forth.

In all cases, positioning of adjacent blocks may require actual physical contact, such as through the use of a keyed surface containing an electrical contact. Alternatively, a wireless connection can be used to communicate data between blocks, such wireless connection being relatively low power (to limit potential inference and to limit broadcast of individual block identities/characteristics to proximate blocks with which an interaction is clearly desired) and realized by technologies well known to the skilled addressee, such as infrared or radio frequency, e.g., Bluetooth™. Ultrasonic transceivers may also be used to establish separation distances between devices realized by physical blocks or tiles.

Communication between blocks may, if desired, be coded and may be established between interacting blocks upon establishment of a handshake that communicates a block identity. Communications between interacting blocks support generation of a coordinated sensory response appropriate to the sensed configuration of the interacting blocks. Communications from one block to another convey relevant information about the transmitting block, e.g. its characterization, which communication may be a simple identity code or more detailed structured message relaying information about the relative positions and characterizations of near-neighbouring, interacting blocks. Information about the blocks (sensed) surroundings/environment may also be communicated.

FIG. 2 is a representation of exemplary configurations for an interactive block 112 shown from left and right perspectives. The term “block” should not be considered limiting. The shape of the interactive block 112 is not critical, although it is preferred that the block has a polyhedral shape that permits easy tessellation, e.g. a cube or a square or rectangular tile. A suitably shaped interactive block 112 is therefore adapted to be orientated with similar functional blocks along or more side edges and generally at least two opposite edges and preferably all its edges to fully support interaction and the ability to change characterization as described above.

In a physical realization, each individual block will have at least one display screen 114 on a surface, such as an LCD display that, preferably, incorporates touchscreen sensing (as is well known in the art). The screen will generally be surrounded by a molded casing 116 that forms a protective enclosure both for the screen and internal electronics. The screen may be multi-layered to support the generation and presentation of 3D images. A typical screen size is in the region of about 5 cm+/−about 2 cm in the principal axis. Obviously, screen size and resolution may be varied, although a typical specification for a square display might be:
a 5 cm×5 cm screen realized by a thin film transistor TFT screen with an active matrix of 2.5″ (6.35 cm) in any suitable aspect ratio;
a resolution of 880×228 RGB delta with a typical pixel size of 56.5×164 HM and a fully integrated single-phase analogue display drivers; and
an input voltage of, say, 3V with a driver frequency of 3 MHz and driver power consumption of 15 mW.

Of course, the screen may have a different specification and resolution and may, for example, be monochrome rather than the preferable 8-bit (or better) coloured display or alternatively the display may be an electrophoretic display provided by E Ink Corporation. Other display technologies will be readily appreciated and may include liquid crystal and cholesteric liquid crystal displays and projected displays, both colour and monochrome.

Adjacent contacting edges of block 112 may be, in certain of the embodiments, adapted to fit together or interlock only when correctly orientated so that both display visual display material 118 the same way up (i.e. top to bottom). For example, as illustrated, the interactive block 112 may include female and male connectors, such as recesses 120 and mating protrusions 122, or just planar connectors strategically positioned on sides or surfaces that are to be aligned. As an alternative to a male-female socket, block surfaces may be sculpted, e.g. made slightly concave/convex. These protrusions and recesses (or the like) may be plastic or metal and their engagement or contact may also be used to generate a control signal that provides a determination (or indication) of close proximity and a deliberate intent to induce an interaction between adjacent blocks. Such recesses 120, protrusions 122 or connectors may be on two or more surfaces of the block and are preferably on all surfaces. Such “registration” features are, of course, optional although beneficial (in certain applications) because they can provide a visual guide during the interaction and alignment processes. The registration features may therefore interlock adjacently located manually manipulable devices and may, in a preferred embodiment, be arranged to cause an indication when registration with another such device is achieved. The indication may be audible or visible in nature, e.g. a “beep” or the production of a symbol at the adjacently aligned edges of the displays 114 on each of the interacting blocks 112. Interlocking only reinforces confirmation of position and orientation, with optical measurement systems (for example), as employed in some embodiments, being adequate in themselves to resolve orientation, relative position and interaction between blocks.

As an alternative, or complementary, way to determine an interacting distance, the blocks include integrated sensors 124 and a corresponding transmitter (see FIG. 3) that permit the block's processor (see FIG. 3) to assess distance and, optionally, also to permit broadcast and reception of data 126. The sensors 124 are shown to be surface-mounted, although this is a design option. A sensor will typically by located on each face that is assigned to trigger and interactive event and, in general, on all faces of the block. With respect to such proximity sensors, a preferred embodiment may make use of an electromagnetic or electrostatic field sensors, or acoustic (or ultrasonic) or electromagnetic beam sensors (e.g. infrared) that commonly look for changes in the field or return signal to infer distance. The sensor type will depend on target casing and therefore the skilled person might select capacitive or photoelectric sensors for plastic targets and an inductive proximity sensor for a metal target.

By way of non-limiting example, inductive proximity sensors are designed to operate by generating an electromagnetic field and detecting the eddy current losses generated when ferrous and nonferrous metal target objects enter the field. The sensor consists of a coil on a ferrite core, an oscillator, a trigger-signal level detector and an output circuit. As a metal object advances into the field, eddy currents are induced in the target. The result is a loss of energy and smaller amplitudes of oscillation. The detector circuit then recognizes a specific change in amplitude and generates a signal which will turn the solid-state output “ON” or “OFF”. The active face of an inductive proximity switch is the surface where a high-frequency electro-magnetic field emerges. A standard target is a mild steel square, one mm thick, with side lengths equal to the diameter of the active face or three times the nominal switching distance, whichever is greater. The use of shielded proximity sensors allow the electro-magnetic field to be concentrated to the front of the sensor face, as will be understood.

Alternatively, the proximity sensor could be based on the use of a plurality of infra-red (IR) sensors on each face, with proximity/distance to an adjacent block 112 determined by measured parallax.

Each block is therefore adapted to sense the proximity of a similar device in any one of multiple adjacent positions, for example, adjacent to each of multiple edges of the device. Each device is preferably further adapted to identify an adjacent device and to communicate information of both the identity and position of an adjacent device to other devices or to the central control unit via said communication unit so that an appropriate response can be generated.

FIG. 3 is a block diagram schematically illustrating preferred functional components of the interactive block 112 of FIG. 2.

In a preferred embodiment, a manually manipulable device/block 112 comprises a 32-bit RISC (or better) processor 150 coupled to a memory 152 arranged to store: i) executable program instructions 154 (e.g. multiple operating routines); ii) an identity 156 of the block (including a current characterization); and iii) a database 158 that stores both reference data (such as animations used to reinforce block characterization and block interactions) and an historical record of interactions experienced by the block 112 over time. The historical record may be non-volatile, or may be resettable upon uploading of program code into memory 150. The processor 150 control operation of the interactive block 112. Whilst a single processor 150 is shown, an alternative embodiment may make use of functionally dedicated processors or ASICs to execute control for particular processes undertaken during the course of play or interaction. For example, the block 112 may include dedicated graphics and audio processors for processing and generating animations of its display(s) 114 and audio output 159 used in generating the block's characterization and associated sensory outputs from a speaker 160.

The processor 150 is typically capable of processing 200 million Instructions per Second (MIPS) or better, although processing capacity is ultimately dependent upon the resource requirements of the operating routines and device functionality. The CPU can preferably address about 16 Mb of Random Access Memory, although it is preferable that the memory capacity is significantly larger to support historical data collection and an improved database of references associated with words, phrases, phonemes, images and musical notes (to name but some examples). The internal storage may be provided by Secure Digital (SD) cards, MultiMedia Cards (MMC), chip-based memory or similar devices.

Preferably, the processor 150 is able to support full motion video at 12.5 frames per second (or better) with 16 bit colour (or better) and synchronized audio.

Processor-controlled generation and playback of audio (in the form of sounds or music) from the speaker is preferably (at least) 4-bit, 4 kHz mono audio (or better). Polyphonic tones or HiFi may also be supported.

As previously explained, in the event that the processors 150 of individual but interacting blocks 112 determine that the arrangement/orientation produces a meaningful sound, word, phrase or image, a complementary sensory output can be generated, such as in the form of vibro-haptic feedback.

Furthermore, should combined characterizations (such as a valid sum, i.e. 2×5=10) interact in a meaningful manner in a row (for example) or an interaction between blocks arises from placement (such as alignment in a column), then a change is individual characterization is triggered and managed by the processors. For example, a change in the visual display material on a similar device may occur so that it matches meaningful interaction or result from the individual characterization presented in the row of interacting blocks 112. As a further example, a strategically placed block 112 located below a row of similar blocks may acquire, under control of a respective processor, a combination of characters as a new characterization, which new characterization reflects a combined output from the logical/meaningful combination of individual characterizations presented in the row, column or array. The block that has acquired the new characterization (of the combination of characters) can then be removed and re-used in a further row, column or array of blocks to create a yet another new combination of characters and a related sensory output.

Generally, each interactive block 112 receives power from an internal power source 162, such as rechargeable lithium or NiMH batteries or the like. However, instances exist when the block is connected to an external computer 164 through an input/output interface 166 (which may be wired or wireless), the block 112 may receive externally produced power through contact pads or otherwise a non-touching inductive path. The input/output interface may feature a microphone permitting recording and storage of sounds detected by the processor 150 during operation of the interactive block 150.

A communications unit 170, responsive to the processor 150, allows each interactive block 112 to receive and transmit data 172, such as its current individual characterization. Transmissions typically are RF-based, although other transmission schemes (such as optical or IR) may be used, as will be understood. For example, the communications unit 170 will preferably support industry standard wireless protocols, including Bluetooth, IrDA, IEEE 802.15.4 or other near field communication protocols.

The interactive block 112 may optionally include a haptic array 176 whose operation is controlled by the processor 150 based, for example, on manipulation of the interactive block 112 as detected by a contact/proximity sensor 178 (whose operation is outlined above) and/or movement sensor 179, such as a micro-machined single-axis (but preferably multi-axis) accelerometer(s). As will be understood, readily available accelerometers are able to detect magnitude and direction of the acceleration as a vector quantity and can therefore be used to sense orientation, acceleration, vibration shock and falling.

The haptic array 176 provides force feedback, including forced feedback sensory responses relating to detected interactions or current characterization or force sensitive feedback based on detected manipulation of the block 112. The haptic array 176 may be provided in the form of a skin covering the block, the haptic array 176 providing tactile feedback accomplished with controllable pin arrays or the like, as will be understood. Under control of the processor 150, the haptic array 176 can be caused, for example, to vibrate to indicate successful interaction between interacting blocks, e.g, a next block in a logical sequence, an error in judgment arising from a meaningless or illogical combination of interacting blocks and/or to provide stimulus to the user. As another example, harder applied pressure to the surface of the block is interpreted in such a way so as to increase audio power output, e.g. harder pressure results in a louder musical note.

Further, detected touch and/or movement of block can be a trigger to effect, under control of the processor 150, sensory output, e.g. annunciation of a sound or generation of an exemplary image associated with the current characterization of the interactive block 112.

One or more of the interactive blocks 112, but preferably each interactive block 112, includes at least camera configured to permit the capture and storage of either still and/or live video images in memory 152. Captured images may be used as visual display material on the display 114, or the image can be used in a visual sensory response.

In a preferred arrangement, multiple cameras may be provided on each interactive block 112. With a camera (or lens coupled to an image sensor and optional coprocessor) strategically located on different (and potentially) all faces or sides, the camera function may be used to process spectrally-acquired data (e.g. image data or IR data) to locate similar interacting devices. The acquired spectral data may also be used to detect the orientation of the block, or changes in orientation; this can complement or replace the use of accelerometers.

Image data may also be used to detect the relative or absolute orientation of near-neighbouring or adjacent interactive blocks. For example, a block may include a resolvable pattern on its surfaces, the pattern associated with orientation of the block and/or unique identity for either a particular block or each face of a particular block.

Capture of the pattern by the camera and resolution of the pattern and/or surroundings (including the user) by the processor therefore provides an indication of orientation or manipulation. Resolving the orientation of a user (such as through facial recognition software) or environmental surroundings can thus be used to imply relative orientation of the block and thus to change (under processor control) the relative orientation of an image presented on one or more displays of a block.

Detected changes in light levels can also be used to infer movement.

For example, faces of the blocks may include one or more light sources (whether IR or in the optical band) that can, optionally, be used as “standard candles”, with the light intensity (detected by a suitably configured camera on another adjacent block) used to determine relative separation and orientation. For example, if each face includes two (or more) fixed position lights sources, the relative separation and/or intensity (as detected by a camera/detector on a remote block) can be processed to determine relative position and orientation.

Optical recognition that a block is proximate may, in some embodiments, be used to administer control of potential interactions. For example, positioning accuracy to effect meaningful interactions and sensory output between interacting characterizations on different blocks may be stricter for users having greater dexterity, e.g. an eight year-old child relative to a three year-old child. Specifically, tolerancing in the positioning of blocks to effect interactions can be selectively controlled or programmed into the control software (executed by the block's processor) to require different, e.g. higher, degrees of placement accuracy.

Since blocks are generally provided with common dimensions, the relative size of a block (as determined from a captured image of that block) can be processed to determine relative distance and/or orientation of the blocks. Particularly, an angular offset will result in edges of a block appearing to taper, with the rate of tapering indicating both angle and orientation.

Hysteresis in image analysis (arising from, for example, variations in light intensities, captured image tapering rates and other similar measures) can thus be used, in certain preferred embodiments, to support the processor's decision-making as to whether a block is or is not positioned to be interacting.

The input/output interface 166 permits each block to be selectively coupled to computer 164 (having an associated process that execute control code), and thus through an interconnected wide area network 190 (such as the internet) to a library database 192. The library database includes content modules 194 (as will be described below) for loading into at least one of the interactive blocks, with content then distributed to other interacting blocks either through a global update command that is broadcast by the connected block or otherwise on an ad hoc basis as the other blocks subsequently interact with the block having the latest identified update. Of course, the content modules 194 could be provided on a CD-ROM 196 or the like, with this loaded directly into the computer 164.

Revised content may be downloaded on an individual basis to individual interactive blocks that are selectively coupled to the computer 164 over a suitable communications resource, such as through a serial connection and a packet-based protocol over the internet.

Each device may have an ON/OFF switch to allow it to activated, deactivated or reset to a start up condition that displays, for example, initial pre-programmed visual display material and an initial individual characterization. Power-off of one device, such as through a time-out or deliberately, may cause broadcast of a general sleep message. Deliberate power-down may cause all blocks to accept an update in the latest program code 154, although this is merely a preferred option.

Similarly, power-down, connection to computer 164 or a direct instruction from input/output interface 166 may cause recorded interaction data to be uploaded (through, for example, an arbitrated and negotiated broadcast) to a single designated block or to a computer for collation and analysis. Analysis may be automated under the execution of program code by a processor or manually performed following review of the uploaded data. Analysis may look for trends in successes or failures brought about through the manipulation of and interaction between interactive blocks or the highlighting of repeated successor or failures. Analysis may take a quantitative value, such as percentage of successful interactions relative to overall attempts. Other measures may be used.

In accordance with a preferred embodiment of the present invention, content output by the various interacting blocks (typically presented in a set of about ten or more) can be dynamically changed over time, the dynamic variation in content arising automatically and in response to historically-recorded manipulations and interactions between individual characterizations presented, from time-to-time, by their respective proximately-located, interacting blocks 112.

Firstly, one or more of the blocks contains hardware and logic to allow it to operate to record and store both detected interactions and detected attempts to cause or produce a meaningful, e.g. logical, interaction between characterizations on blocks.

In this way, an ‘f’ block's processor would record both an attempt to join it to an isolated ‘x’ block and would also record the successful but ordered interaction with an ‘at’ block to produce the word and annunciation “fat”. But, the combination ‘at’ and ‘f’ would yield a recorded attempt, but no success. In this way, the recorded interactions provide an indication or rate of poor judgment or randomness by the user over time, and also a relative rate of success, such as 100% correct from a given number of attempts or 95% correct in unit time. Since the individual characterizations of the block change with time, the instantaneous characterization of the block is recorded since this information permits trend analysis and identification of areas of potential weakness in strategy or learning, e.g. a consistent misspelling of a word through the incorrect use of a particular letter. The nature and form of analysis of not limited to these alphabetic examples, but rather extend to musical notes and mathematical relations. For example, if a block is programmed with a musical stave showing “middle C” as its initial characterization, its processor could be arranged to monitor the frequency of an audio input to correlate whether the user had generated “middle C”, e.g. on a keyboard or musical instrument. Indeed, the processor could record the time taken to identify and play the “middle C”, or relative timing (against the note of phrase duration given the bar timing) employed to produce a musical phrase.

The processor 150 therefore operates to record in local database 158 all relevant interaction data to produce an historic record for at least its own block (or a set of blocks). To simplify the requirement for providing communication updates between all interacting blocks within a local set, a preferred embodiment of each interactive block (and control sub-routine) operates to record only its own interactions and then to download these upon request or upon connection to a computer, e.g. through input/output interface 166. Also, although the logical interactions between individual characterizations are of principal importance in assessing use, all interactions (including those that transfer/replicate individual characterizations to other blocks) may be recorded and downloaded. If an assigned block acts as a master, then periodic broadcast of locally recorded interactions are received by the assigned block to produce a composite

Upon request or at the point of connection to a host PC 164 or server, the processor 150 operates to cause the uploading of historical data for computational analysis by either an expert or, preferably, an automated software routine executed at the host. Based on the computational analysis, the host correlates the analysis with available (stored) content that is designed, when downloaded, to re-enforce the user's current understanding by: i) providing similarly-skilled content that is focused to specific areas of identified weakness or deficiency; ii) decreasing skill or aptitude levels required in new content to be downloaded to the interactive blocks 112 to make the formulation of interactions simpler; iii) increasing the difficulty of interactions or the length of phrase formation, e.g. extending the length of words that can be formed using a plurality of interacting blocks; or iv) providing alternative content (such as new pictures and recognized word or phoneme combinations) to refresh and enliven the activity.

An alternative or complementary wireless embodiment sees interaction data regularly communicated to and assessed at a central computer that responds to reported interactions by sending revised content updates or broadcasting intelligent prompts that cause blocks with viable current individual characterizations to produce substantially simultaneous sensory responses to encourage manipulation and effective interaction. Updates may be sent on a regular basis, for example every few minutes or at other shorter or longer intervals.

In a preferred embodiment, the remote analysis and the provision of content updates can be subject to a financial transaction, with content and resources provided at the centralized server and from the remote library 192. Access to the analysis and the content may be obtained through internet access, such as through computer 160 and WAN 190, and either a subscription or ad hoc payments. Alternatively, the computer 164 can be provided with a variety of loadable modules burnt onto a CD-ROM (or the like). In the latter respect, revised content is extracted from the CD-ROM 196, with the computational analysis sub-routines initially provided with the CD-ROM 196 for loading into the local host computer 164.

Computational analysis quantifies measureable statistics or events such as: i) misspellings; ii) implied misunderstanding (e.g. the visual letter ‘f’ is the first letter of an image of a balloon, as presented on two separate displays on two distinct blocks 112); iii) rates of response, with slower rates implying lack of familiarity; iv) percentage error rates; v) timing errors, especially in the context of musical scores; and vi) similar qualitative or quantitative measures known in education assessment.

In an embodiment, the interactive blocks may further include locomotion actuators and a driver that cooperate to permit the block 112, under the control of its processor, to move as part of a meaningful interactive response.

In yet a further enhancement or embodiment, each block may include a broad spectrum projector operating in the visual or IR frequency bands. The projector is operationally responsive to the processor and functions to project visible or non-visible patterns, including holograms and/or grids, to assist in determining relative movement, gestures by a user or relative position. Such information can thus be used to modify sensory output from each interacting block.

In wireless-based embodiment employing cameras in similar interactive blocks, captured visual information gathered by the various cameras is communicated either between blocks or to a central processing resource (such as computer 160) to allow assembly of a virtual model of the environment within the visual fields of the cameras. Reported information permits both the location and movement of individual blocks to be assessed, and also the relative location and movement of other objects within the field, including the location and movement of the blocks' users. The central resource or the local processors are then able to generate a sensory response based on the location and movement of devices themselves, and also the location and movement of other objects within the field, including the location and movement of the blocks' users to modify sensory output from each interacting block. For example, in appreciating the local environment and relative positioning of blocks, spatial sensory output (represented as located sounds within a three dimensional sound spatial array or stereophonic array) can be selectively generated, e.g. to help identify location of potentially interacting blocks, by surround sound or stereophonic audio equipment, such as may be experienced with headphones connected to a 2D display supporting multiple virtual interacting objects/blocks.

FIG. 4 shows a software-based implementation of interactive virtual objects 212 in the context of a processor-controlled touch screen 214 of a laptop computer or tablet 216 or the like. The software-based implementation may have been downloaded from a computer readable medium, such as a USB memory stick or the like. Interactions are typically brought about by the dragging of one virtual block towards one or other virtual blocks. The size of the blocks may be varied based on expressed content presented within the area assigned to the virtual block. Successful interaction may make use of the entire screen for a temporary period of time before reverting to the wider virtual environment in which multiple blocks/objects are present. The laptop 216 therefore embodies both the hardware and software functions described above, particularly in relation to FIGS. 1 to 3.

Referring now to the exemplary flow diagram of FIG. 5, the process begins with the loading of code and the presentation 300 of a default (or random) individual characterization for a particular block 12. In an operational state, the block then interrogates its current environment (e.g. through optical scanning, manipulation, wireless connectivity or contact) to detect 302 whether there is any similar block within an interacting range. If no block is detected (branch 304), then the block essentially remains in a monitoring mode, unless the system may be set up to determine whether inactivity, i.e. non-interaction, has timed-out 306 in which case the block may enter a power save or sleep state to preserve battery life. For example, if there's been no activity for say 5 minutes, a decision is made as to whether to power off (step 308, 310) or whether the inactivity warrants a potential change in current individual characterization presented by the block 312.

In the event that an interaction is detected 314, a determination is made (generally by interacting local processors) to determine the nature of the interaction 316 based on current individual characterizations and/or block orientation and/or relative positioning. One or more appropriate sensory responses may therefore be generated 318, if appropriate, at one or more blocks or remotely to the blocks 12. If the interaction warrants a change (step 320 and branch 322) in individual characterization, then a new individual characterization is retrieved from memory and presented 324, as discussed above. Otherwise (following negative branch 326), the process continues. In either case, the nature of the interaction(s) (and the current characterizations or identities of and) between the interacting blocks is recorded 328. At an appropriate point, an accumulated historical record of interactions is uploaded 330 from block to a centralized assessment resource.

At the centralized resource, the nature of the block interactions is generally categorized 332, with trend analysis executed 334 to identify whether a trend exists (affirmative branch 336) or whether the results should simply be stored 338 for ongoing reference and future computation in trend analysis with newly uploaded data. Trend analysis is typically automated in the central resource through use of a software program that looks for specific, unusual or incorrect responses in the dataset.

In the event that a trend exists, as discussed above, the central resource may notify 340 the existence of the trend. A determination 342 may be made as to whether the blocks that have reported the trend are fully subscribed to receive selected content updates or modified operating instructions. If there is no current subscription, the ability to subscribe may be offered 344 to the user. Should the subscription be in place (whether free or not), then tailored content and/or control parameters for the block(s) are selected, with such resources or code downloaded 348 to one or more blocks for subsequent use in presenting new individual characterizations and sensory responses.

Ordering of operational processes within the flow diagram of FIG. 5 may be varied and processes may, in fact, occur in parallel.

### Social and Micro-Networks

FIG. 6 shows a preferred social network 600 that makes use of interactive iTiles 112 to establish connectivity between remote users. Establishment of the secure social network may be considered as a precursor to a network call or remote interactions. Presently, web-access represents a security concern for parents, with firewalls and other local software controls on computers designed to inhibit access of (particularly) younger or vulnerable children to morally corrupt individuals or harmful media content provided in chat rooms and the like. The interactive block technologies of the present invention provide a mechanism of secure access and control.

By way of explanation, the preferred processor-controlled interactive block 112 of FIG. 3 includes memory 152, I/O interface 166 and a camera 180; these elements may be used to effect establish of a connection between remotely located computers over a LAN or WAN 190. More specifically, two sets of interactive blocks (or, in fact, two iTiles) are owned by different children. By making use of a computer, contact details (such as an e-mail account, a computer address or the like) can be programmed via the interactive block's interface 166 and stored in local memory 152.

The computer may require a dongle 602 or other connection interface to the iTile, with this technology readily known. In fact, the computer 160 may initially be used to code an entire set of iTiles with ownership and contact data 601, although general set coding could equally be preformed at the point of manufacture, whereafter any added tiles would simply make use of inter-iTile interactions to establish the a local network set.

To provide an added level of security, a biometric identity 603 for the interactive block's authorized user (or users) may preferably be acquired via the camera 180, analyzed by the processor 150 and then stored in memory 152. The biometric identities are therefore also tied to stored and cross-referenced to specific contact details. Biometric data may take the form of a physical assessment of features of a face, or other unique measures for an individual (such as a fingerprint or iris colour).

The interactive nature of each set of iTiles means that programming may be limited to one block, with that block then distributing the programmed contract details to other blocks in the set with which the programmed block interacts. This is not a conventional master-slave relationship, but rather a distributed control system since any interactive iTile can act as an initial port for receipt (in essence) metadata relevant to the set of interactive blocks.

In the social networking situation, two children may each own sets of iTiles, with these sets (or even just one interactive tile from each set) brought together in a controlled social environment, such as in a classroom or during an arranged visit to one of the homes of one of the children. The fact that the sets of iTiles interact means that “My Contact” details 601 (such as a name and a related computer address, url or e-mail account) may be transferred from one block in a first set 604 to a second block in a second set 606 (and thus onwardly but controllably propagated, at an appropriate time of interaction) to other iTiles in the second set 606 only). The fact that the children have interacted in person is thus recorded in each set of iTiles, with the personal contact providing a level of reassurance.

The transferred contact details (which may also include non-editable picture) acquired by the second set 606 (from the first set 604) are therefore temporarily storable in an editable directory (termed “Your Contact” 610 in FIG. 6). Stored entries in the “Your Contact” data list can thus be selectively deleted, e.g. via an edit command provided directly by the iTile or otherwise via a connected local computer.

In a preferred embodiment, transfer of contact details requires a specific invitation at the point of interaction between two tiles from different sets. Of course, it is also contemplated that casual play involving physical, i.e. proximate, interactions between iTiles can solicit a transfer of contact details without a specific invitation to effect a social connection.

The sets of tiles may therefore have fundamentally different identities that uniquely identify iTiles within each set, with the identity being based, for example, on biometric data acquired at the point of initialization of the set or extension of the set. The use of differentiable sets of iTiles provides a mechanism that restricts uncontrolled dissemination of contact details via iTile interactions. Contact details are preferably therefore only transferred from proximal interacting contact, so stored third party “Your Contact” 610 data is only disseminated within its own set and not onwardly to other different sets. Conversely, “My Contact” data is shareable between all iTiles belonging to an established set.

Once the two sets 604, 606 of iTiles have been separated, contact between the users may be re-established via a computer-network-computer connection controlled and the use of the transferred contact details. Particularly, the iTile establishes a connection to a home computer, with the iTile or home computer providing access to transferred “Your Contact” 610 data. Selection of a stored friend's contact details can be achieved either via the iTile user interface (e.g. a touch screen display or tap sensors located on sides of the iTile) or via the computer, with positive selection causing a network connection to be established (under processor control) to the corresponding electronic address or web site, as the case may be. Since the point-to-point connection is based on prior personal contact and prior direct interaction between specific sets of iTiles, confidence about the social connection is assured. Contact detail selection may, equally, be voice controlled, with the iTile supporting voice recognition.

As a further security measure, a preferred embodiment makes use of the biometrically encoded data in each set of iTiles. Specifically, in the set up of a connection via a networked computer, selection of the connection path may be prevented unless the iTile used to establish the call identifies the user's features as corresponding to the stored biometric data. Biometric information is preferred over other password-based schemes since young users do not need to be bothered with remembering passwords and periodic biometric scanning is generally non-invasive and unobtrusive. This additional security check means that contact data stored in the iTile cannot be accessed by unauthorized third parties to contact remote individuals who might otherwise presume that the contact request (and subsequently established social communication session) emanated from a known friend.

Equally, to permit a call to be picked up and a social communication session to be established, an iTile at the remote location may require a biometric identification of the recipient before connection is established and authorized. In this fashion, the calling party is ensured that the receiving party is indeed a friend and someone with whom it is permissible to interact over the network.

From a basic structural perspective (having regard to these different aspects of social networking and/or interaction in micro-networks—whether via a WAN or in close physical proximity, e.g. in a classroom or playground situation), each iTile need only be realized by an electronic manually manipulable device having: a processor; a replenishable power supply typically in the form of a rechargeable battery; a display supporting powered presentation of a first individual characterization having a first property, the first individual characterization changeable over time by processor control; a communication unit allowing data to be received and transmitted to said manually manipulable device; and a sensor array configured to sense proximity and relative position of a second similar device movable independently of said first manually manipulable device. [From the perspective of the second similar device, this second similar device is brought, in use, into data communicating proximity with the manually manipulable device through manipulation of one of the manually manipulable device and/or the second similar device, with the second similar device further presenting a second changeable individual characterization independent of the first individual characterization. The second changeable individual characterization has a second property different to the first property and wherein communication of data provides a context about meaningful interaction between the manually manipulable device and at least the second similar device]. From a functional perspective, each manually manipulable device 112 (“iTile”) is arranged or configured, during interaction between the first individual characterization and at least the second individual characterization, to inherit a new property and to change the first individual characterization to a third individual characterization (e.g. the letter “b” may change to the letter “t” or letters “be”, or a number may change to a different number, or a colour to a different colour or shade), wherein the new property and the third individual characterization presented by said manually manipulable device are dependent on one of: (i) the second individual characterization on the second similar device and the relative position between said manually manipulable device and the second similar device; and (ii) an interacting combination of the first and second properties and the first and second characterizations. The interaction therefore means that the change to the third individual characterization permits the manually manipulable device, i.e. the iTile 112, to interact differently with similar proximately located devices having their own individual characterization.

In effect, in social and micro-networks established by interactions between different sets of interactive blocks (whether across a network connection or otherwise by local wireless communication), the iTiles 112 therefore act as arbitrators at both the local and remote ends (in the sense of specific and different sets of interactive tiles) of the communication session, since each iTile is able to store allowable connections to identified friends, each can control a connection request by restricting the set-up process to an authorized user only and each can limit to an authorized user the acceptance and establishment of, and ongoing participation in, a communication session. The iTiles of a preferred embodiment thus form a micro-network of first-tier (direct) contacts; this is illustrated by the touching engagement of the set borders for the first and second sets 604 and 606. In contrast, a third iTile set 608 is isolated from the first and/or second sets 604, 606 because none of its iTiles has interacted proximally with either of the iTiles in the first and second sets to secure an invitation to join the mirco-network presently comprised from the first and second remotely located sets. Of course, the third set 608 of iTiles can again be connected to the LAN/WAN through a computer (labeled 164″ in FIG. 6), and it may be possible in the future for the third set to form its own unique micro-network or alternatively join the first set 604 and/or the second set 606.

By way of further explanation, if the first set 604 is confirmed as part of a first micro-network that includes the second set 606, and the third set 608 is made part of a second micro-network comprising the first set 604, this would permit an iTile in the first set to interact remotely with an iTile in the second and/or third sets. But, an iTile in the second set 606 would not be able to interact directly with an iTile in the third set 608 unless the second and third sets were invited to join one another following a recognized interaction mechanism at a point of physicality.

In the alternative, an iTile in the first set 604 might (under defined conditions) operate as a relay between an iTile in the second set 606 and an iTile in the third set 608. The term “relay” is coined to reflect that the iTile in the first set may in some way modify received content/properties received from, for example, an iTile in the second set before the iTile in the first set can communicate its changed properties to an iTile in the third set and thus interact differently (relative to its initial interaction with the iTile in the second set) with the iTile in the third set. In this fashion, the iTile in the first set acts as an arbitrator to moderate non-first tier connections and resulting interactions.

Once the second and third sets are joined, then an expanded micro-network of first tier contacts would exist between the first set 604, the second set 606 and the third set 608, with this expanded mirco-network permitting direct three-way interaction over the WAN/LAN 190.

In micro networks containing two or more sets (and especially three or more sets), control of interactions may be based on a round-robin sequence which is agreed and adhered to by the interacting sets of iTiles; this agreement may be pre-set or agreed as a parameter of micro-network interaction. The round-robin sequence may also be subject to a time limit to produce a time-division system where a ‘no response’ within a set window of time moves the sequence on. Alternatively, control can make use of a synchronized micro-network or universal time that supports a first come, first served basis that queues a limited number of contiguous interaction requests and optionally truncates that queue to action only those interactions that are pertinent in real time to characterization and properties presented on targeted iTiles.

Established micro-networks may comprise two or more sets of iTiles, since the micro-network is scalable. However, at any point in time a user may select (and thus restrict) the number of interacting sets of iTile by selecting only specific entries from the list of first tier (“Your Contact” 610) contact details.

Each micro-network therefore includes at least two sets of iTiles generally sharing a first tier contact relation, with the degree of physical separation determining whether a communication relay (such as WAN or the internet) is required to support communication and interaction. Each set may comprise one of more interacting iTiles 112.

Periodic biometric checks may be conducted at timed or random intervals during any connection to ensure that the contact is limited to authorized users.

It is again emphasized that the formation of social and micro-networks of FIG. 6 (as detailed above) can be entirely independent of the process of particularly FIG. 5, since: a) the dynamic alteration of content; b) the generation of a sensory-perceivable prompt to indicate at least one possible interaction that would result in a meaningful arrangement of individual characterizations presented by similar devices; c) the provision of interaction data arising from manipulation and interaction between devices; and d) the provision of reports or scoring and/or trend analysis of manipulations and interactions between devices does not require the establishment of a secure and remote social and/or micro-networks. Rather, the social and micro-networking aspects described herein merely complement and augment the embodiments of FIGS. 2 to 5 to provide a richer overall functional system, with FIG. 6 therefore realizable independently.

Unless specific arrangements are mutually exclusive with one another, the various embodiments described herein can be combined to enhance system functionality and/or to produce complementary functions that improve resolution of, for example, estimations of distance or position. Such combinations will be readily appreciated by the skilled addressee given the totality of the foregoing description. Likewise, aspects of the preferred embodiments may be implemented in stand alone arrangements where more limited functional arrangements are appropriate, e.g. arising from a lack of physical space on a block or a cost of providing duplicated cameras, detectors and lens systems on two or more faces. Indeed, it will be understood that unless features in the particular preferred embodiments are expressly identified as incompatible with one another or the surrounding context implies that they are mutually exclusive and not readily combinable in a complementary and/or supportive sense, the totality of this disclosure contemplates and envisions that specific features of those complementary embodiments can be selectively combined to provide one or more comprehensive, but slightly different, technical solutions.

Unless the context specifically requires, the term “device”, “block”, “tile”, “object”, “ITile(s)” and the like are used interchangeably and reflect both virtual and physical processor-controlled realizations that present changeable individual characterizations. Similarly, the term “display” should be construed broadly to encompass all such suitable display technologies.

It will, of course, be appreciated that the above description has been given by way of example only and that modifications in detail may be made within the scope of the present invention. For example, the blocks may actually be realized by a software-app located into an MP3 player or the like, such as an iPod™ from Apple, Inc. Employed in this environment, such MP3 players may download a configured software-app to permit the MP3 player to take on a changeable individual characterization and to interact with similarly configured electronic devices to produce a local interacting set.

1. A manually manipulable device comprising:
a processor arranged to control operation of the device;
a power source providing power to the device;
a visual display unit arranged to display visual display material;
a response generator for generating a sensory response;
a communications unit configured, in use, to effect communication with a similar manually manipulable device; and
wherein the device is configured to present a changeable individual characterization represented by display of visual display material and wherein the processor generates a sensory response in its response generator or a sensory response in a response generator of a similar device, the generated sensory response dependent upon at least one of the individual characterization presented by the device itself and an individual characterization presented by the similar device, the sensory response output by the response generator follows manual manipulation of the device and interaction between changeable individual characterizations, the interaction dependent upon relative position between the device and at least an adjacently located interacting device;
the manually manipulable device further includes a position and positioning and proximity device configured to sense and determine the relative position; and wherein:
the changeable individual characterization of the manually manipulable device represented by display of visual display material takes the form of at least one of: a letter; a group of letters; a word; words; a number; a mathematical symbol; or a musical symbol;
the individual characterization on the similar device represented visually as: a letter; a group of letters; a word; words; a number; a mathematical symbol; or a musical symbol, and
the individual characterization of the manually manipulable device is controlled by the processor and selectively changeable over time based upon: i) the nearby detection of the similar device; and ii) the individual characterization presented on that similar device at the time of its detection; and iii) the relative position between interacting devices;
the processor configured or arranged to effect at least one function selected from the group consisting of:
a) dynamically altering content representing changeable individual characterizations, the content varied in response to historically accumulated manipulation data relating to interactions experienced by the device over a selected period of time;
b) determining available interactions with adjacent devices and generating a sensory-perceivable prompt to indicate at least one possible interaction that would result in a meaningful arrangement of individual characterizations presented by similar devices; and
c) providing interaction data arising from manipulation and interaction between devices; and
d) providing reports or scoring of manipulations and interactions between devices.

2. The manually manipulable device according to claim 1, wherein the processor is further configured or arranged to:
record and store successful interactions that combine to generate a sensory output;
record and store failed interactions that produce no logical or meaningful sensory event from a relative positions arising between proximately located devices;
wherein the records are, upon request, uploadable.

3. The manually manipulable device according to claim 1, wherein the processor is further configured or arranged to permit selective modification in the responsiveness of the sensory output to relative position data.

4. A learning system comprising a multiplicity of interacting devices according to claim 1, the system further including:
a computing system having a database of content, the computing system responsive to historically accumulated interaction data uploaded, in use, from one or more of said interacting devices,
wherein the computing system is configured to arranged to:
analyze historically accumulated interaction data; and
identify trends in the historically accumulated interaction data; and
in response to identification of any trend, to retrieve content from the database and download the content to at least one the multiplicity of interacting devices, the content changing at least one of:
the changeable individual characterizations;
a nature of interactions between individual characterizations; and
sensory outputs arising from interactions between individual characterizations presented on different ones of the multiplicity of interacting devices.

5. The learning system of claim 4, wherein at least one of access to the computing system and the content in the database is subject to an on-line log-in process.

6. The learning system of claim 4, wherein the computing is automatically arranged to cause selective download of new content, new operating instructions and new content and operating instructions to one or more of the interactive devices based on either at least one of:
identified trends in the historically accumulated interaction data; and
educational scores reflecting success or failure rates in recorded interactions between interacting devices.

7. A computer program product that, when run on a computer, includes code that is arranged to:
generate a visual display containing a plurality of user-positionable objects that each present a changeable individual characterizations, the changeable individual characterizations represented by display of visual display material
cause generation of a sensory response associated with at least one interacting device, the generated sensory response dependent upon at least one of the individual characterization presented by a first user-positionable object and an individual characterization presented by a second user-positionable object, the sensory response output following manipulation of at least one of the first and second objects and interaction between changeable individual characterizations presented thereon, the interaction dependent upon relative position between the first object and at least the second object adjacently located and interacting therewith;
determining a relative position and proximity between user-positionable objects;
selectively change over time the individual characterizations based upon: i) the determined position of similar objects; and ii) the individual characterization presented on those similar objects at the time of their detection; and at least one of:
a) dynamical alteration of content representing changeable individual characterizations, the content varied in response to historically accumulated manipulation data relating to interactions experienced between user-positionable objects over a selected period of time;
b) determine available interactions between adjacent objects and cause generation of a sensory-perceivable prompt to indicate at least one possible interaction that would result in a meaningful arrangement of individual characterizations presented by the objects; and
c) accumulate and provide reports derived from manipulation and interaction between objects; and
d) accumulate and score manipulations and interactions between objects;
wherein the changeable individual characterizations of the objects are represented by display of visual display material taking the form of at least one of: a letter; a group of letters; a word; words; a number; a mathematical symbol; an image; or a musical symbol.

8. A method of altering sensory responses in an education device or toy having a display with a changeable individual characterization represented visually as: a letter; a group of letters; a word; words; a number; a mathematical symbol; an image; or a musical symbol,
the individual characterization changeable with time based upon i) the nearby detection of the similar device; ii) the individual characterization presented on that similar device at the time of its detection; and iii) the relative position between interacting devices, and wherein
the sensory response is dependent upon at least one of the individual characterization presented by the device itself and an individual characterization presented by the similar device, the sensory response output following:
manual manipulation of the device;
interaction between changeable individual characterizations; and
relative position between the device and at least an adjacently located interacting device;
the method comprising:
a) dynamically altering content representing changeable individual characterizations presentable by the educational device, the content varied in response to historically accumulated manipulation data relating to interactions experienced by the device over a selected period of time;
b) determining available interactions with adjacent devices and generating a sensory-perceivable prompt to indicate at least one possible interaction that would result in a meaningful arrangement of individual characterizations presented by similar devices;
c) providing interaction data arising from manipulation and interaction between devices; and
d) providing reports or scoring of manipulations and interactions between devices.

9. The method of altering sensory responses according to claim 8, the method further comprising:
analyzing historically accumulated interaction data;
identify trends in the historically accumulated interaction data; and
in response to identification of any trend, retrieving content from a database and downloading the content to at least one interacting device, the content changing at least one of:
the changeable individual characterizations;
a nature of interactions between individual characterizations; and
sensory outputs arising from interactions between individual characterizations presented on different ones of the multiplicity of interacting devices.

10. A processor-controlled object on which is presented a processor-generated, processor-controlled changeable individual characterization represented by display of visual display material, the processor-controlled object configured or arranged:
to generate and present under powered processor-control first visual display material, the first visual display material having a first changeable individual characterization with a first property;
to sense proximity and relative position of second visual display material generated and presented under processor-control on a second object movable independently of said processor-controlled object, the second object brought into processor-resolvable interacting proximity with said processor-controlled object by manipulation of one or more of said processor-controlled object and the second object, the second visual display material having a processor-controlled second changeable individual characterization independent of the first individual characterization, the second changeable individual characterization having a second property;
in response to processor-resolved interaction between said first and second changeable individual characterizations arising from sensed near proximity and relative position of said processor-controlled object and the second object, to generate a user-perceivable sensory response that is output from a response generator, wherein the user-perceivable sensory response is dependent upon said sensed relative positions of the first visual display material to the second visual display material and is indicative of a contextual relationship that arises between said first property of the first changeable individual characterizations and the second property of the second changeable individual characterizations;
selectively and autonomously to change with time under processor control the first changeable individual characterization with the first property to a third changeable individual characterization with a third property such that the third changeable individual characterization is presented on said processor-controlled object, the third property different to the first property;
to determine new processor-resolvable interactions involving said processor-controlled object now having the third changeable individual characterization and to generate and output corresponding new user-perceivable sensory responses from the response generator to reflect new processor-resolvable interactions exhibiting contextual relationship.
the processor configured or arranged to effect at least one function selected from the group consisting of:
a) dynamically altering content representing changeable individual characterizations, the content varied in response to historically accumulated manipulation data relating to interactions experienced by the device over a selected period of time;
b) determining available interactions with adjacent devices and generating a sensory-perceivable prompt to indicate at least one possible interaction that would result in a meaningful arrangement of individual characterizations presented by similar devices; and
c) providing interaction data arising from manipulation and interaction between devices; and
d) providing reports or scoring of manipulations and interactions between devices.

11. A manually manipulable device having:
a processor;
a display supporting powered presentation of a first individual characterization having a first property, the first individual characterization changeable over time by processor control;
a communication unit allowing data to be received and transmitted to said manually manipulable device; and
a sensor to sense proximity and relative position of a second similar device movable independently of said first manually manipulable device, the second similar device brought, in use, into data communicating proximity with said manually manipulable device through manipulation of one of said manually manipulable device and the second similar device, the second similar device further presenting a second changeable individual characterization independent of the first individual characterization, the second changeable individual characterization having a second property different to the first property and wherein communication of data provides a context about meaningful interaction between said manually manipulable device and at least the second similar device;
wherein the said manually manipulable device is arranged or configured:
during interaction between the first individual characterization and at least the second individual characterization, to inherit a new property and to change the first individual characterization to a third individual characterization, wherein the new property and the third individual characterization of said manually manipulable device are dependent on one of:
(i) the second individual characterization on the second similar device; and
(ii) an interacting combination of the first and second properties and the first and second characterizations; and
to effect at least one function selected from the group consisting of:
a) dynamically altering content representing changeable individual characterizations, the content varied in response to historically accumulated manipulation data relating to interactions experienced by the device over a selected period of time;
b) determining available interactions with adjacent similar devices and to generate a sensory-perceivable prompt to indicate at least one possible interaction that would result in a meaningful arrangement of individual characterizations presented by similar devices; and
c) providing interaction data arising from manipulation and interaction between devices; and
d) providing reports or scoring of manipulations and interactions between devices.

12. The manually manipulable device according to claim 2, wherein the processor is further configured or arranged to permit selective modification in the responsiveness of the sensory output to relative position data.

13. The learning system of claim 5, wherein the computing is automatically arranged to cause selective download of new content, new operating instructions and new content and operating instructions to one or more of the interactive devices based on either at least one of:
identified trends in the historically accumulated interaction data; and
educational scores reflecting success or failure rates in recorded interactions between interacting devices.
